(19) United States
(12) Patent Application Publication
(10) Pub. No.: US 2002/0043180 A1
(43) Pub. Date: Apr. 18, 2002

(54) Composition for underground pipe repair

(76) Inventors: Andrew Bayliff, Lancashire (GB); Frank Andrews, Kent (GB); Gary R. Latto, Willowbrook, IL (US); Stephen E. Russell, Grayslake, IL (US)

Correspondence Address: NIXON & VANDERHYE P.C., 1100 North Glebe Road, 8th Floor, Arlington, VA, 22201, US

(21) Appl. No.: 09/942,022

(22) Filed: Aug. 30, 2001

Related U.S. Application Data
(63) Continuation of application No. PCT/US00/06114, filed on Mar. 10, 2000.

(30) Foreign Application Priority Data
Mar. 12, 1999 (GB) 9905652.5

(51) Int. Cl. C08L 91/06

(52) U.S. Cl. 106/270

(57) ABSTRACT

A wax-based composition for repairing defects in underground pipes in situ. The composition comprises wax and a dewetting agent. The dewetting agent is preferably an ethoxylated acetylenic diol.

This invention concerns a composition for repairing defects such as holes, cracks and defective joints in underground pipes. In particular, this invention concerns compositions for repairing the defects in situ and without excavation of the defective underground pipe.

U.S. Pat. No. 5,194,193 discloses a composition for use in repairing underground pipe defects in situ. A section of the underground pipe including the defect is isolated using inflatable plugs. A molten sealant such as wax is then injected into the isolated section. The preferred wax is slack wax or paraffin wax.

The aim of the present invention is to provide an improved composition for repairing defects in underground pipes in situ. In particular, the aim of the present invention is to provide a composition that exhibits improved hole plugging ability and adhesion to standard pipes under normal conditions of use.

In accordance with the present invention there is provided a wax-based composition for repairing defects in underground pipes in situ, the composition comprising at least one wax and at least one dewetting agent.

The dewetting agent is preferably an ethoxylated alcohol. One such material is SURFYNOL HS-30, an ethyoxylated acetylenic diol, which is available from Air Products.

The dewetting agent may also be preferably selected from: alkanolamides, alkylaryl sulfonates, alkyl benzene sulfonic acids, amine acetates, amine oxides, betaine derivatives, ethoxylated alkylphenols, ethoxylated amines, ethoxylated amides, ethoxylated fatty acids, ethoxylated fatty esters (such as, for example, MAYPEG 400 MS from BASF), fatty amines, fatty esters, fluorocarbon surfactants (such as, for example, FLUROAD FC-430 from 3M), glucose ester derivatives, glycerol esters, glycol esters, imidazolines and derivatives, lanolin and derivatives, lecithin and derivatives, lignin and derivatives, monoglycerides and derivatives, olefin sulfonates, oxazolines, petroleum sulfonates, phosphate esters, polyethylene glycols and derivatives, propoxylated surfactants, protein based surfactants, quarternary surfactants, sarcosine derivatives, silicon based surfactants, soaps, sorbitan derivatives, sulfates, sulfonates, sucrose ester derivatives and/or sulfosuccinates and derivatives.

The dewetting agent may be non-ionic, anionic or cationic.

The inventors have found that the dewetting agent is required to improve adhesion of the wax-based composition to the underground pipes.

The inventors have also found that their wax-based composition can be used to repair wet or damp underground defective pipes whilst still achieving the required adhesion to repair the defect.

The wax-based composition also preferably includes an additive for controlling viscosity, for improving plasticity (and by plasticity is meant flexibility and elongation), and/or for improving tack for better adhesion. The improved flexibility and adhesion promotes improved impact resistance, which is measured by dropping a 20 gram steel ball on to a 10 gram wax plaque of 85 mm in diameter from a height of 1 meter. The additive is preferably an amorphous or partially amorphous additive such as a rubber, a thermoplastic polymer and/or a glassy resin.

The inventors have found that the composition of the present invention is capable of sealing larger defects than the paraffin wax disclosed in U.S. Pat. No. 5,194,193.

The composition preferably comprises greater than 45% by weight, more preferably greater than 50% by weight, even more preferably greater than 60% by weight, even more preferably greater than 70% by weight, and most preferably greater than 80% by weight, of wax.

The composition preferably comprises from 0.01 to 1.0% by weight, more preferably from 0.05 to 0.5% by weight, and most preferably from 0.1 to 0. 3% by weight, of the dewetting agent.

The wax-based composition of the present invention is rubbery solid in nature (i.e. it is not in the form of a gel).

The composition may also include root inhibitors to prevent plant growth around the repair.

The composition may also include biocides to prevent degradation of the wax-based composition in use.

The invention will now be described, by way of example, with reference to the following example:

The following composition was prepared:

| | |
|---|---|
| Astor 5530 | 86.3% |
| Proxmelt 4365 | 13.5% |
| Surfynol HS-30 | 0.2% |

Astor 5530 is a microcrystalline wax, available from Astor Inc., having a 155° F. melt point.

Proxmelt 4365 is a predispersion of butyl rubber, available from Dussek Campbell Inc.

Surfynol HS-30 is an ethoxylated acetylenic diol, available from Air Products and Chemicals Inc.

The composition exhibited the following characteristics:

| Example | Results |
|---|---|
| Volumetric contraction between 91-22° C. | 13.75% |
| Vertical deflection at break | >16 mm |

The results can be compared to the results achieved using a fully refined paraffin wax 135/40:

| Fully Refined Paraffin Wax 135/40 | Results |
|---|---|
| Volumetric contraction 91-22° C. | 18.68% |
| Vertical deflection at break | 1 mm |

Contraction results are calculated from a base line of 100% at 22° C.

Conditions of the three point bend test were as follows:

Test pieces—square section bars 9×9×90 mm;

Speed of vertical travel-40 mm/min;

Span of two outer points-65 mm, third point positioned centrally.

Paraffin wax forms an adequate matrix with soil surrounding a damaged pipe; however, there is little or no adhesion between the wax and soil matrix. Therefore, the defect could reopen if there is any movement of the soil. The paraffin wax also shows poor adhesion to the interior of a wet clay pipe. This poor adhesion could prevent seals from forming, or allow the wax to be washed off Paraffin wax is also very brittle. Therefore, the repair could be easily damaged by just a slight impact.

A repair made using the composition prepared above in accordance with the present invention exhibited excellent adhesion to the pipe, which would withstand movement of the soil. It was found by the inventor that the composition could advantageously be used on a wet pipe. The composition is solid in nature with good flexibility. Therefore, it can withstand flexure of the pipe due to earth movements etc.

The present invention therefore exhibits improved properties over a composition made from just fully refined paraffin wax.

What is claimed is:

1. A wax-based composition for repairing defects in underground pipes in situ, the composition comprising at least one wax and at least one dewetting agent, wherein said composition comprises greater than 45% weight wax.

2. The wax-based composition claimed in claim 1, wherein the dewetting agent is selected from: alkanolamides, alkylaryl sulfonates, alkyl benzene sultonic acids, amine acetates, amine oxides, betaine derivatives, ethoxylated alkylpheriols, ethoxylated alcohols, ethoxylated amines, ethoxylated amides, ethoxylated fatty acids, ethoxylated fatty esters, fatty amines, fatty esters, fluorocarbon surfactants, glucose ester derivatives, glycerol esters, glycol esters, imidazolines and derivatives, lanolin and derivatives, lecithin and derivatives, lignin and derivatives, monoglycerides and derivatives, olefin sulfonates, oxazolines, petroleum sultonates, phosphate esters, polyethylene glycols and derivatives, propoxylated surfactants, protein based surfactants, quartemary surfactants, sarcosine derivatives, silicon based surfactants, soaps, sorbitan derivatives, sulfates, sutfonates, sucrose ester derivatives and/or sulfosuccinates and derivatives.

3. The wax-based composition claimed in claim 2, wherein the dewetting ) agent is an ethoxylated alcohol, preferably ethoxytated acetylenic diol.

4. The wax-based composition claimed in any one of the preceding claims, wherein the dewetting agent is a non-ionic surfactant.

5. The wax-based composition claimed in any one of the preceding claims, wherein the composition further includes an additive for controlling viscosity, for improving plasticity and/or for improving tack.

6. The wax-based composition claimed in claim 5, wherein the additive is an amorphous or partially amorphous additive.

7. The wax-based composition claimed in claim 6, wherein the additive is a rubber, a thermoplastic polymer and/or a glassy resin.

8. The wax-based composition claimed in any one of the preceding claims, wherein the composition comprises greater than 45% by weight, more preferably greater than 50% by weight, even more preferably greater than 60% by weight even more preferably greater than 70% by weight, and most preferably greater than 80% by weight, of wax.

9. The wax-based composition claimed in any one of the preceding claims, wherein the composition comprises from 0.01 to 1.0% by weight, more preferably from 0.05 to 0.5% by weight, and most preferably from 0.1 to 0.3% by weight, of dewetting agent.

10. The wax-based composition claimed in any one of the preceding claims, the composition further including at least one root inhibitor.

11. The wax-based composition claimed in any one of the preceding claims, the composition further including at least one biocide.

12. The wax-based composition claimed in any one of the preceding claims, the composition having a volumetric contraction when cooled from 90 to 22° C. of less than 14.5%, calculated from a base line of 100% at 22° C.

13. A method for repairing a defect in an underground pipe in situ, the method comprising the steps of:
(a) liquefying the wax-based composition defined in any one of the preceding claims;
(b) inserting the liquefied wax-based composition into the defective pipe, optionally under pressure;
(c) causing or allowing the wax-based composition immediately in contact with the defect to solidify; and
(d) removing, preferably by pumping, the bulk of the wax-based composition that is still molten.
